(19) United States
(12) Patent Application Publication
(10) Pub. No.: US 2013/0200304 A1
(43) Pub. Date: Aug. 8, 2013

(54) ACTIVE OXYGEN SOURCE

(71) Applicants: Mona Ezzelarab, Helsingborg (SE); Anna Fureby, Huddinge (SE); Anders Larsson, Akersberga (SE); Tove Åberg, Bandhagen (SE)

(72) Inventors: Mona Ezzelarab, Helsingborg (SE); Anna Fureby, Huddinge (SE); Anders Larsson, Akersberga (SE); Tove Åberg, Bandhagen (SE)

(21) Appl. No.: 13/574,681

(22) PCT Filed: Jan. 24, 2011
(86) PCT No.: PCT/SE11/50068

§ 371 Date: Jan. 4, 2013

(30) Foreign Application Priority Data
Jan. 29, 2010 (SE) 1050096-5

(51) Int. Cl. C09D 101/02

(52) U.S. Cl. CPC C09D 101/02
USPC 252/186.25

(57) ABSTRACT

The present invention relates to a solid active oxygen source coated with a composition comprising at least one polymer, wherein the composition on the oxygen source has been subjected to heating. Said oxygen source is chosen from percarbonates and said polymer is a hydrophobic alkyl cellulose, preferably ethyl cellulose. In a further aspect the present invention relates to a process for the production of a coated active oxygen source, wherein said oxygen source is in solid state and is formed into or in the shape of a granule, and wherein the coating is applied onto the oxygen source and subjected to heating by an application-drying process.

### FIELD OF THE INVENTION

The present invention relates to a solid active oxygen source coated with a polymer composition giving in a slow or prolonged release and the process for producing said oxygen source

### BACKGROUND OF THE INVENTION

Within different applications it is desirable to obtain a controlled release of substances.

Detergents comprise different substances e.g. generally an oxygen-based bleach and a bleach activator or precursor. In solid detergent compositions these compounds are typically admixed as separate granules to the base composition. However, it is also known within the field to coat oxygen-based bleach with different coatings in order to protect the bleach in view of handling of the compound.

Sodium percarbonate has different uses, for example as bleach in detergents, for fish farming, soil remediation etc. The sodium precarbonate decomposes during such uses into water, soda and oxygen and is accordingly an environmental friendly agent. The most used types of coating material for sodium percarbonate are inorganic salts and to some extent also silicates and borates. The purpose of the salts is to protect the particles during handling. Silicates and borates may be used to control the release rate of the active oxygen content.

Ethylcellulose coatings are known within the pharmaceutical field and are used for coating of drugs to receive a controlled release at the same time as obtaining a protective coating.

Within the field of soil remediation mention can be made of a publication by W. J. Davis-Hoover, L. C. Murdoch, S. J. Vesper, H. R. Pahren, O. L. Sprockel. C. L. Chang, A. Hussain and W. A. Ritschel, “Hydraulic Fracturing to Improve Nutrient and Oxygen Delivery for In Situ Bioreclamation” in: R. E. Hinchee and R. F Olfenbuttel (Eds.), In Situ Bioreclamation Applications and Investigations for Hydrocarbon and Contaminated Site Remediation, Butterworth-Heinemann, Stoneham, Mass., 1992, pp. 67-82. This document relates to in situ delivery of nutrients and oxygen in soil. Disclosed is microencapsulation of sodium percarbonate powder in ethylcellulose by an emulsion/solvent evaporation process. In the process ethylcellulose is dissolved in acetone, and sodium percarbonate powder is dispersed in this solution. The formed dispersion is emulsified using liquid paraffin and polyoxyethylene sorbitan monooleate. Thereafter the solvent is removed and the encapsulated sodium percarbonate is washed with hexane. The solvents used in the process are flammable, irritant, harmful and dangerous for the environment. Since such organic solvents are used the process requires expensive and complex equipment that is classified as explosive proof for safety reasons. Also, the use of such solvents is hazardous for working environment reasons.

If a controlled release rate of oxygen in situ in a mixture, e.g. a more distinct slow release or sustained release of oxygen could be obtained from a solid active oxygen source, which may take several hours or days compared to known processes and/or if a process for producing a slow release active oxygen source could be done in a more cost effective and/or more environmentally and/or working environment friendly way this would be desirable.

Thus, there still exists a need to find new ways to control, slow down and/or prolong the release of oxygen from an active oxygen source. Also, there exists a desire to try and adapt manufacturing processes to more environmentally friendly and/or working environmental friendly ways and raw materials, and using regular unclassified equipment instead of more expensive explosive proof apparatuses. Also, a need for compounds that are easier to handle are desired.

### SUMMARY OF THE INVENTION

The present invention relates in one aspect to a solid active oxygen source coated with a composition comprising at least one polymer and wherein the composition on the oxygen source has been subjected to heating.

The oxygen source may chosen from percarbonates, preferably sodium or potassium salts of percarbonates, more preferably sodium percarbonate. Preferably the oxygen source have a median particle size of 0.01-3 mm, preferably 0.05-1.2 mm. Said polymer in the composition may be chosen from hydrophobic alkyl cellulose. The composition may further comprises a plasticizer, preferably present in an amount of 1-30% by weight, preferably 5-25%, 10-25%. The composition may be in an amount of 1-40% by weight of the total coated particle, preferably 2-35%, 2-30%, 3-25%, 5-20%.

The present invention relates in a further aspect to the process for the production of a coated active oxygen source, wherein said oxygen source is in solid state and is formed into or in the shape of a granule, e.g. tablet, pastille, bar or agglomerate, and wherein the coating is applied onto the oxygen source and subjected to heating in an application-drying process. The application and drying process involves preferably a multistage drier, drum, spouted bed and/or fluid bed. The temperature when the coated oxygen source is subjected to heating is preferably about 40-100° C., preferably 50-90° C., more preferably 60-85° C.

### DETAILED DESCRIPTION OF THE INVENTION

The present invention relates to ways being able to fully take advantage of the oxidizing properties in different applications, thus a controlled release of the oxygen content is valuable. The use of an active oxygen source in solid state makes handling issues easier compared to oxygen sources in fluid state, both liquid and gaseous state.

An object of the invention is to provide a coated active oxygen source which exhibits a controlled release mechanism resulting in a slow or sustained release of oxygen in situ.

In one aspect the present invention relates to an oxygen source coated with a composition comprising at least one polymer and wherein the coated oxygen source is subjected to heating. The oxygen source in solid state is preferably chosen from the group consisting of percarbonates, preferably sodium or potassium salts thereof, more preferably sodium percarbonate. Preferably the oxygen source has a median particle size of 0.01-3 mm, preferably 0.1-2 mm, preferably 0.2-1.2 mm, without the coating, if of a spherical shape.

The coating composition is preferably in an amount of 1-40% by weight of the total coated particle, preferably 2-35%, 2-30%, 3-25% or 3-20%, by weight of the total coated particle. Said at least one polymer is preferably chosen from the group consisting of hydrophobic alkyl cellulose, preferably ethyl cellulose. Said polymer is present in an amount of 70-99.9% by weight of the coating composition, preferably 75-90%.

Said coating composition may further comprises a plasticizer, which may be chosen from white spirit, esters, ketones, ether alcohols, glycols and hydrophilic ether alcohols, as examples mention can be made of 3-hydroxy-2,2,4-trimethyl-pentyl isobutyrate, diesters of adipic acid, dimethyl phthalate, 2-hydroxypropyl ethylhexanoate, benzyl benzoate, 2-(1-cyclohexenyl)cyclohexanone, cyclohexanone, isophorone, ethylene glycol ether derivatives, propylene glycol derivatives, butyl glycol, propylene glycol butyl ether, dipropylene glycol butyl ether and N-methylpyrrolidone. The plasticizer is preferably chosen from the group consisting of dibutyl sebacate, acetylated monoglycerides, glyceryl triacetate, acetyl triethylcitrate, acetyl tributylcitrate, triethyl citrate, dibutylphthalate, diethylphthalate, tributylcitrate, preferably dibutyl sebacate. Said plasticizer is preferably present in an amount of 1-30% by weight of the coating composition, preferably 10-25%, preferably 5-25%.

Said coating composition may further comprise a diluent, preferably being water. If water is used as diluent the manufacturing process wherein the coated particle is subjected to heating unclassified equipment could be used.

In one aspect of the present invention the coated oxygen source is degradable.

In another aspect the process according to the present invention relates to an oxygen source being formed into or is in the shape of a granule by granulation, agglomeration, pelletization or compaction. Said oxygen source in a desired shape is coated in a coating apparatus, preferably in a drum or a spray drier, e.g. a multistage drier, spouted bed or fluid bed, preferably fluid bed. Preferably the oxygen source is coated by spraying in a suitable equipment. During and/or after the application of the coating, the coated particle is subjected to heating, preferably in a drum, multistage drier, spouted bed or fluid bed, preferably fluid bed. The coating applied to or being applied to the oxygen source is subjected to temperatures of about 40-100° C., preferably 50-90° C., more preferably 60-85° C. Preferably the application of coating and heating are made using spray drying and fluid bed drying technologies, i.e. multistage drier, spouted bed or fluid bed. More preferably both coating and heating is done within the same apparatus.

Without being bound by theory it is believed that the coating on the oxygen source particles is releasing its diluent when being subjected to the heating, e.g. evaporation of water. It might however, also occur further curing mechanisms giving synergic effects. Subjecting the particle to heating may thus in this application also be referred to as drying.

The glass transition temperature is the temperature where polymers go from being hard and brittle to soft and flexible. At this temperature parts of the polymeric chain can move and not only single atoms, resulting in a softer polymer. The glass transition temperature is very different among different polymers.

If the temperature is above the minimum film formation temperature the latex particles will then deform and a polymer film be created. Below that temperature, no continuous film will be formed. To obtain a non-porous film it is necessary that the drying does not occur too close to the minimum film formation temperature.

To make the mechanical properties of a polymer better a plasticizer can be added. The plasticizer will increase the distances and the free volume between the polymer chains. Hence the intermolecular forces between them will be lower. The addition of a plasticizer will lower the glass transition temperature and make the polymer more able to create flexible coatings with a reduced tendency for cracking. Increasing amounts of plasticizer will decrease the glass transition temperature at least to a plateau level.

The application and/or heating temperature in the process of coating particles has to be higher than the minimum film formation temperature. An ethylcellulose coating has a minimum film formation temperature of about 81° C. If a plasticizer is added to an amount of 10-20% this temperature is lowered to 20-50° C.

The film formation process can continue for several days after the coating process is finished. This might alter the release properties, making the coating release its content at a slower rate than before. It might depend on the coalescence of the polymer particles that will decrease the free volume and chain mobility and hence also the permeability. To avoid this problem, to get the best results in diffusive coating and to make the coating reach its stable state, the coated particles need to be subjected to heating. The heating must be done at a temperature higher than the glass transition temperature or at a temperature at least 10° C. above the minimum film formation temperature. If a coated particle is not dried and contains only low amounts of plasticizer the release rate will be high. This is because the film does not completely cover the coated material.

Polymeric coatings with plasticizer can absorb higher amounts of water than the ones without. This makes it easier for the coated material to escape through the coating. Plasticizers with different properties will affect the coating in different ways. As preferred examples mention can be made of dibutyl sebacate, acetylated monoglycerides, glyceryl triacetate, acetyl triethyl citrate, triacetin, acetyltributyl citrate, dibutylphthalate, diethylphthalate, tributyl citrate, preferably dibutyl sebacate. The properties of the dry coating are also completely different to those when the coating is wet.

Apart from the plasticizer and pore former other additives which are known within the field may be used in order to achieve a stable coating composition. Among such additives surfactants, processing aids—rheology control additive (thixotropic agents), bonding agents, thinners, stabilizers may be mentioned.

The obtained coated product according to the present invention may be used within different fields such as water treatment, oil extraction, odor control or in any application where an in-situ solid oxygen source is useful, e.g. for automatic dishwashing products, laundry bleach or other household and industrial cleaning, fish farming, soil remediation, pond remediation, oil well stimulation (guar breaker), odour control (in waste water treatment, municipal and industrial sludge, compostation etc), anti corrosion caused by H₂S forming bacteria in pipes.

The invention shows that hydrophobic alkyl cellulose, preferably ethyl cellulose can be used as an effective coating for an oxygen source such as percarbonate to give controlled release properties. The coated product has very low tendency to form agglomerates after their production and is stable for months at normal room temperature.

This type of coating provides a larger spectrum of release rates compared to commercially available coatings. The release profiles can be varied by small alterations in the spray content and conditions, thus making it possible to tailor-make coatings for the release rate required.

To obtain the slow and/or sustained release when coating below minimum film formation temperature, addition of plasticizer is necessary. The most important parameters to control the release are the amount of plasticizer and the heating temperature of the finished coating. Other parameters are addition of a pore former, and the thickness of the coating.

The invention presents an opportunity for utilisation in a broad range of applications where controlled release of a solid oxidiser is needed. An addition of a plasticizer, e.g. dibutyl sebacate, to the dispersion of ethyl cellulose will lower the Tg from about 90° C. to about 40° C.

### Examples

To meet the demands of a solid active oxygen source with slow and/or sustained release properties a polymer coating was tested on sodium percarbonate granules. Such a coating could be applied to other oxygen sources, where a delayed or sustained release is needed.

Uncoated sodium percarbonate granules (trade name ECOX U from Kemira Kemi AB) were coated in a fluidized bed with ethyl cellulose dispersion. Some of the coated materials were additionally heated in an oven after the coating.

The coated particles were studied by measuring their release rate in water and the hydrogen peroxide content.

The tests showed that it is possible to use a cellulose coating to adjust the release rate for sodium percarbonate particles immersed in water. The most important parameters for adjusting the release rate are addition of a plasticizer and heating of the coated particles. It is possible to obtain a variation in the release rates from minutes to days.

### Preparation of the Coating Solution

A typical coating material was ethylcellulose in an aqueous dispersion. A plasticizer, in this case dibutyl sebacate, was used to lower the minimum film formation temperature and facilitate the formation of the film. Small amounts of NaCl were added in some experiments with the purpose to lower the electrostatic forces.

A commercial ethyl cellulose was used in the present examples. Aquacoat® ECD is an aqueous suspension containing ethylcellulose (24.5-29.5% by weight), sodium lauryl sulphate (0.9-1.7% by weight) and cetyl alcohol (1.7-3.3% by weight). The latter two are process aids in the production of said suspension. The non-aqueous content was assumed to be the mean value of the lowest and the highest amount of the dry material, 30.8% by weight. In all experiments only the dry material in Aquacoat® ECD was regarded as coating. The used amounts of plasticizer were percentages of these coating weights. All the contents and percentages can be seen in table 1. The amount of coating was expressed as percentage by weight of the total coated particle.

The weighed amounts of Aquacoat® ECD, deionized water and dibutyl sebacate were stirred a few minutes at high speed with a magnetic stirrer until the solution seemed homogeneous.

### The Spray Coating Process

### Equipment:

### Pro-C-epT 4M8 Fluidbed 1 Liter.

### Pump Watson Marlow, SciQ, 400, 403U/R1, 50 RPM

Sodium percarbonate 200 g was used every time with the spraying co-currently to the particle movements.

The air speed 0.3 m³/min, the nozzle pressure 1 bar and the blowback time 6/0.5. The bed temperatures in the different experiments at this time were kept low as a safety precausion and varied between 40-55° C. A typical value was 42° C.

The solution to be sprayed on the particles was stirred in a beaker beside the apparatus during the entire process.

The air flow, without heating, was allowed to continue for 10 minutes after the coating was finished to dry the coatings and cool the particles.

### Conductivity Measurements

The dissolution time was measured by conductivity. Conductivity measurements were performed with a WTW, Cond 340i with Tetracon 325. 1000 ml of deionized water was adjusted to 19.5-20.0° C. The water was stirred during the whole measurements. 2.00 g of the sample was added. The coating does not contribute to the conductivity. The conductivity values after 10, 60 and 120 minutes were used for the evaluation of oxygen release (dissolution rate).

TABLE 1
The amount of coatings, their contents and heating conditions

Heating

| Experiment No | Coating % | DBS % | 50° C. | 60° C. |
|---|---|---|---|---|
| 1 | 10 | | | |
| 2 | 10 | 12 | | |
| 3 | 10 | 24 | | |
| 4 | 10 | 24 | | 2 h |
| 5 | 10 | 24 | | 1 h |
| 6 | 10 | 24 | 1 h | |
| 7 | 3 | 24 | | |
| 8 | 3 | 24 | | 2 h |
| 9 | 7 | 24 | | |
| 10 | 7 | 24 | | 2 h |
| 11 | 5 | 24 | | |
| 12 | 20 | 24 | | |

### Results

The purpose of this investigation was to verify the possibility of a cellulose coating for slow release of active oxygen. As ethyl cellulose contains ether groups with a potential risk for unstable peroxide formation.

### Percentage of DBS:

When evaluating the effect of a plasticizer samples with tree different DBS contents were prepared, experiment 1-3.

From the results, FIG. 1, it can be seen that at the same coating amount the increased DBS content significantly retarded the dissolution rate.

### Heating:

When the particles were coated the temperature were about 40-55° C. in the equipment. In order to check the effect of heating at higher temperatures and different periods of time some coated particles were then subjected to further heating in an oven at a temperature above the minimum film formation temperature to receive a more completed film formation. Heating was performed at 50 and 60° C. for one and two hours. The choice of a separate further heating step was made for safety reasons.

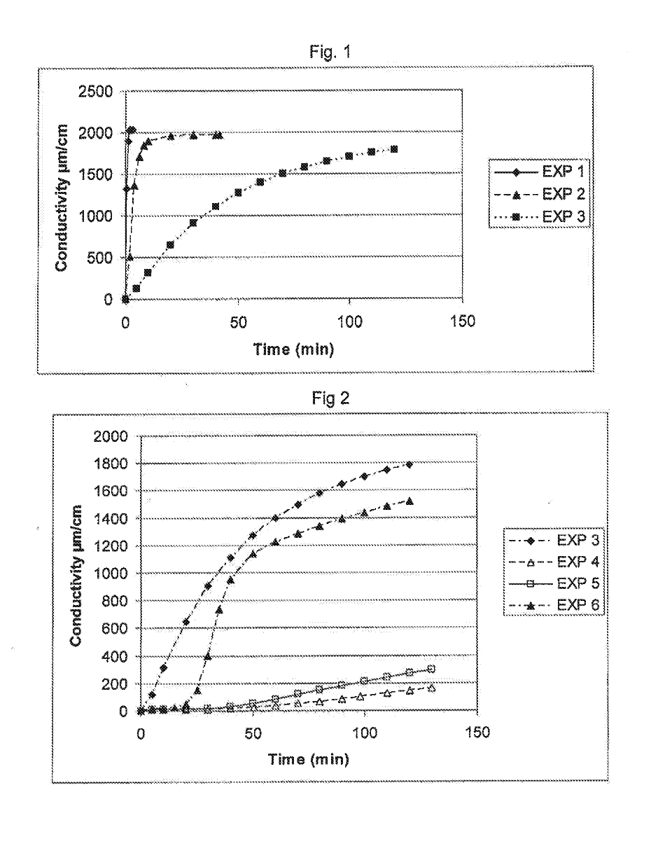

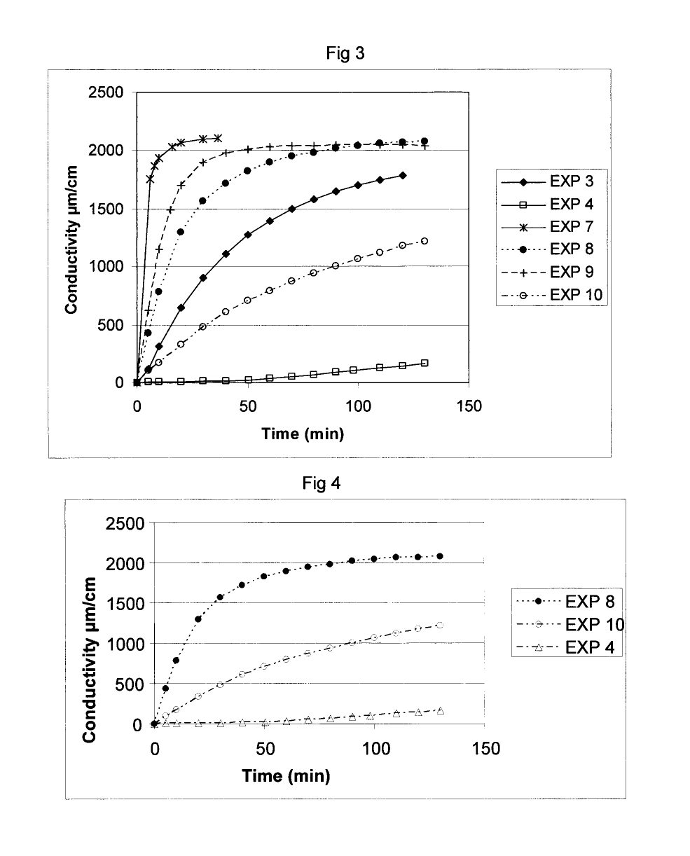

By subjecting the coated granules to heating the release rate was decreased substantially. Both increased heating time and temperature decreased the release rate, see FIG. 2. Subjecting the particles to heating at higher temperature for a longer time is more efficient than an increased layer thickness of the coating, see FIG. 3.

By subjecting the coated granules to heating the release rate was decreased. For some compositions the difference was quite considerable and if slow release is desired, the use of heating is often more efficient than a thicker layer of coating. The herein used variation between the temperatures is only 10° C. but the difference it caused to the release rate was very large.

### Layer Thickness of the Coating:

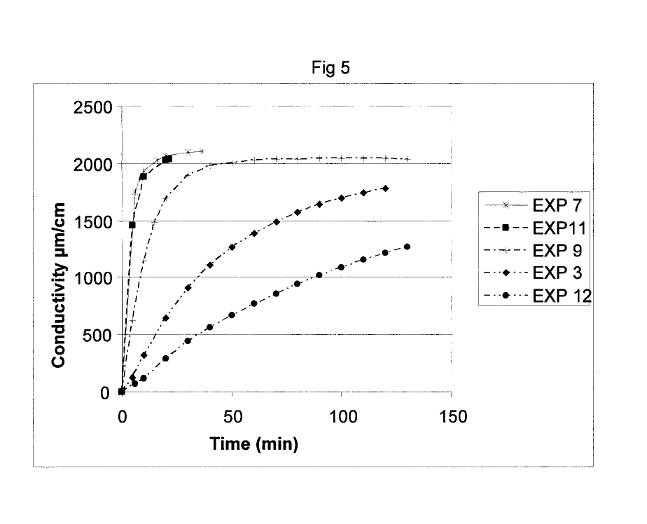

The effect of different coating thicknesses can be seen in FIGS. 4 and 5. A higher the coating percentage resulted in a slower the release rate regardless of whether the sample was subjected to heating, see FIG. 4 or not, FIG. 5.

### Reference Examples

### Raw Materials

Sodium percarbonate, SPC, (from Kemira Kemi AB under the trade name ECOX U) and sodium silicate from Askania, Sweden, with a dry content of 36% by weight and a molar ratio (MR) of 3.3+/−0.2. were used for the coating trials.

### Lab Scale Trials

The coatings of the sodium percarbonate granules (ECOX U) were performed in an AGT 150 fluid bed from Glatt (Germany).

Silicate coating trials were performed with ingoing air flow of 115-135 m³/h with temperature of 110-125° C., ECOX bed of 2-3 kg with bed temperature of 83-85° C.

The amount of silicate coating was calculated as the sum of Na₂O and SiO₂ (see Equations 1-3 below).

Eq. 1: Si content by analysis 10% (10 g/28.1 g/mol)*60.1 g/mol=21.4 g
Eq. 2: SiO2 Water glass contains Na₂O: 8.77 wt %, SiO₂: 27.85 wt % (21.4/27.85)*8.77=6.7 g Na₂O
Eq. 3: 21.4 g+6.7 g=28 g Na₂SiO₃=28% Na₂SiO₃

The samples were coated with a theoretical value from 10% and 20% Na₂SiO₃.

The conductivity values after 10, 60 and 120 minutes were used for the evaluation of oxygen release (dissolution rate).

TABLE 2

| | Coating | Si | Conductivity, μS/cm | | |
|---|---|---|---|---|---|
| Sample # | Calculated coating % | (wt %) | 10 min | 60 min | 120 min |
| Ref Exp 1 | Na₂SiO₃ 10% | 3.6 | 856 | >2000 | >2000 |
| Ref Exp 2 | Na₂SiO₃ 20% | 7.1 | 236 | 1178 | 1759 |
| Exp 3 | Coating 10%, DBS | | 294 | 1397 | 1780 |
| | 24% | | | | |
| Exp 12 | Coating 20%, DBS | | 162 | 794 | 1176 |
| | 24% | | | | |

When comparing the results of experiments 3 and 12 according to the present invention to Reference experiments 1 and 2 is clear that the dissolution time of sodium percarbonate can be significantly extended with a cellulose coating compared to equal amount of a sodium silicate coating according to prior art.

The tests showed that it is possible to use a cellulose coating to adjust the release rate for sodium percarbonate particles immersed in water. The most important parameters for adjusting the release rate are addition of a plasticizer and subjecting the coated particles to heating. It is possible to obtain a variation in the release rates from minutes to hours.

1. A solid active oxygen source coated with a composition comprising at least one polymer, characterized in that said oxygen source is chosen from sodium or potassium salts of percarbonates and said polymer is chosen from hydrophobic alkyl cellulose and wherein the composition on the oxygen source has been subjected to heating at a temperature higher than the glass transition temperature or at a temperature at least 10° C. above the minimum film formation temperature.

2. An oxygen source according to claim 1, wherein said oxygen source is sodium percarbonate.

3. An oxygen source according to claim 1, wherein said polymer is ethyl cellulose.

4. An oxygen source according to claim 1, wherein said composition further comprises a plasticizer.

5. An oxygen source according to claim 4, wherein said plasticizer is chosen from the group consisting of 3-hydroxy-2,2,4-trimethyl-pentyl isobutyrate, diesters of adipic acid, dimethyl phthalate, 2-hydroxypropyl ethylhexanoate, benzyl benzoate, 2-(1-cyclohexenyl)cyclohexanone, cyclohexanone, isophorone, ethylene glycol ether derivatives, propylene glycol derivatives, butyl glycol, propylene glycol butyl ether, dipropylene glycol butyl ether and N-methylpyrrolidone, dibutyl sebacate, acetylated monoglycerides, glyceryl triacetate, acetyl triethylcitrate, acetyl tributylcitrate, triethyl citrate, dibutylphthalate, diethylphthalate, tributylcitrate, preferably dibutyl sebacate.

6. An oxygen source according to claim 5, wherein said plasticizer is present in an amount of 1-30% by weight, preferably 5-25%, 10-25%.

7. An oxygen source according to claim 1, wherein said composition is in an amount of 1-40% by weight of the total coated particle, preferably 2-35%, 2-30%, 3-25%, 5-20%.

8. An oxygen source according to claim 1, wherein said oxygen source has a median particle size of 0.01-3 mm, preferably 0.05-1.2 mm.

9. A process for the production of a solid oxygen source according to claim 1, wherein said oxygen source is formed into or in the shape of a granule, preferably tablet, pastille, bar or agglomerate,
wherein said coating is applied to the oxygen source and subjected to heating at a temperature higher than the glass transition temperature or at a temperature at least 10° C. above the minimum film formation temperature by an application and drying process.

10. A process according to claim 9, wherein said application and drying process involves a multistage drier, drum, spouted bed and/or fluid bed, preferably fluid bed.

11. A process according to claim 9, wherein said coating is applied in an amount of 1-40% by weight of the total coated particle, preferably 2-35%, 2-30%, 3-25% or 3-20%, by weight of the total coated particle.

12. A process according to claim 9, wherein the temperature when the coated oxygen source is subjected to heating is 40-100° C., preferably 50-90° C., more preferably 60-85° C.
